(19) United States
(12) Patent Application Publication
(10) Pub. No.: US 2026/0123598 A1
(43) Pub. Date: May 7, 2026

(54) SELF-PROPELLED MANURE VACUUM WITH BOTTOM OR SIDE UNLOADING

(71) Applicant: Mensch Manufacturing, L.L.C., Hastings, MI (US)

(72) Inventors: Noah Mensch, Hastings, MI (US); Donald Mensch, Hastings, MI (US)

(21) Appl. No.: 18/935,820

(22) Filed: Nov. 4, 2024

(51) Int. Cl. A01K 1/01; A47L 7/00; A47L 9/06; A47L 9/14; B60P 1/56; B60P 3/22

(52) U.S. Cl. CPC A01K 1/0128; A47L 7/009; A47L 9/0606; A47L 9/149; B60P 1/56; B60P 3/2245; B60P 3/225; B60P 3/2265; A47L 2201/04

(57) ABSTRACT

The present disclosure relates to a versatile vacuum truck system designed for efficient collection, transport, and unloading of organic matter. Different embodiments can support side, bottom, and front unloading or different combinations thereof, facilitated by a controllable auger. The truck can feature a side spreading system with a guillotine door and brass knife valve, allowing for precise material distribution. The system can be configured for bulk dumping or controlled spreading, making it adaptable to various agricultural tasks. The flexible design optimizes performance in diverse environments, from large-scale field applications to confined spaces, enhancing efficiency and operational control.

### BACKGROUND OF THE INVENTION

The present invention relates to vacuum trucks configured for efficient collection and unloading of organic matter, such as manure, crop residues, and stall material (e.g., bedding materials such as straw, wood shavings, or sawdust), and unloading of same. More particularly, the present invention relates to a self-contained, self-propelled, steerable vacuum truck that can unload collected organic matter under or off the side of the truck.

In modern large-scale animal, farming, and dairy operations, equipment is rugged, durable, and efficient to meet the demands of frequent and time-consuming tasks, such as the collection and unloading of organic matter from animal stalls. The maneuverability of vacuum trucks during the unloading process, particularly when approaching pits for front or rear unloading, presents significant operational challenges. Any unintended vehicle movement or brake failure during this process can result in the vacuum truck falling into the pit, leading to potential equipment damage and safety hazards.

Additionally, rear unloading often involves the operator backing the vacuum truck up to the pit, making it challenging to monitor the process from the cab at the front of the vehicle. If organic matter becomes lodged during unloading, the operator may be unaware, leading to significant delays. In the case of front unloading, while monitoring from the cab is easier, the process often causes organic matter to splatter, obstructing the operator's view and necessitating more frequent cleanings to maintain clear visibility. Additionally, while unloading organic matter in front of the vehicle, the vehicle's wheels and undercarriage can interfere with the discharged material. This interference can cause the organic matter to become spread unevenly or trapped, leading to inefficiencies in the unloading process and potentially requiring additional cleanup or adjustments to the vehicle's positioning.

### SUMMARY OF THE INVENTION

In one aspect of the present disclosure, a manure vacuum truck with side or bottom unloading includes a self-propelled steerable vehicle having a frame. A storage tank and scraper are mounted on the frame or tank, the scraper defining a collection area for scraped organic material. A suction line connects the collection area to the storage tank. A vacuum source is operably connected to at least one of the collection area, the suction line, and the storage tank for creating suction to move the manure material from the collection area along the suction line into the storage tank. The storage tank includes an outlet opening for unloading the storage tank beneath the vehicle or off the side of the vehicle. The storage tank further can include an auger with opposed flighting sections to move the manure within the tank to the tank outlet for unloading. In embodiments that accommodate side or bottom unloading as well as front unloading or back unloading, the auger can include all forward flighting or all reverse flighting, depending on whether the second exit is at the front or rear of the truck.

In some side unloading embodiments, the side unloading system can be configured with a side spreading system to either selectively passively dump or actively spread collected organic material from the side of the vehicle.

These and other aspects, objects, and features of the present invention will be understood and appreciated by those skilled in the art upon studying the following specification, claims, and appended drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 illustrates a front perspective view of a bottom unload vacuum truck embodiment of the present disclosure.

FIG. 2 illustrates a front perspective view of a side unload vacuum truck embodiment of the present disclosure.

FIG. 3 illustrates a side view of the side unload vacuum truck embodiment of FIG. 2.

FIG. 4 illustrates a close-up exploded side view of the side unload system of the vacuum truck of FIG. 2.

FIG. 5 illustrates a front view of the side unload vacuum truck embodiment of FIG. 2.

FIG. 6 illustrates a front perspective view of a side unload vacuum truck embodiment with a side spreader system.

FIG. 7 illustrates a close-up exploded view of the side spreader system of the vacuum truck of FIG. 6.

### DETAILED DESCRIPTION OF THE CURRENT EMBODIMENTS

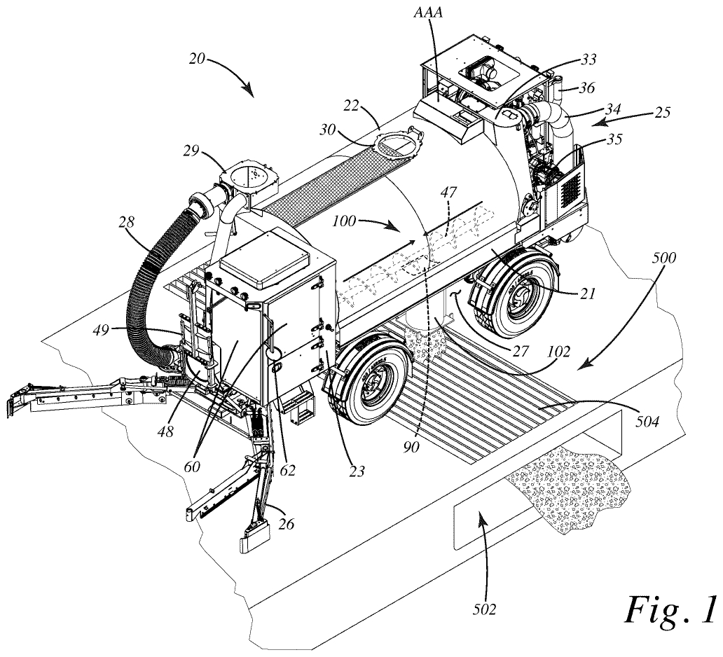

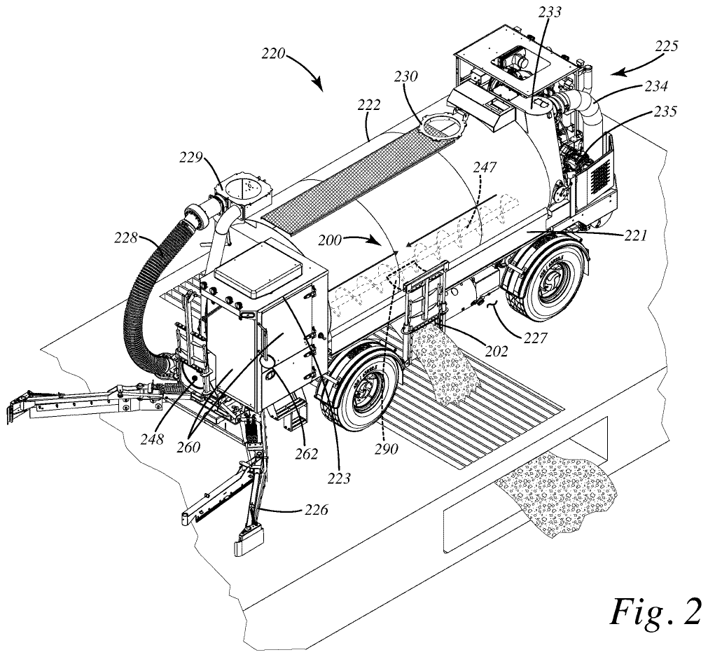

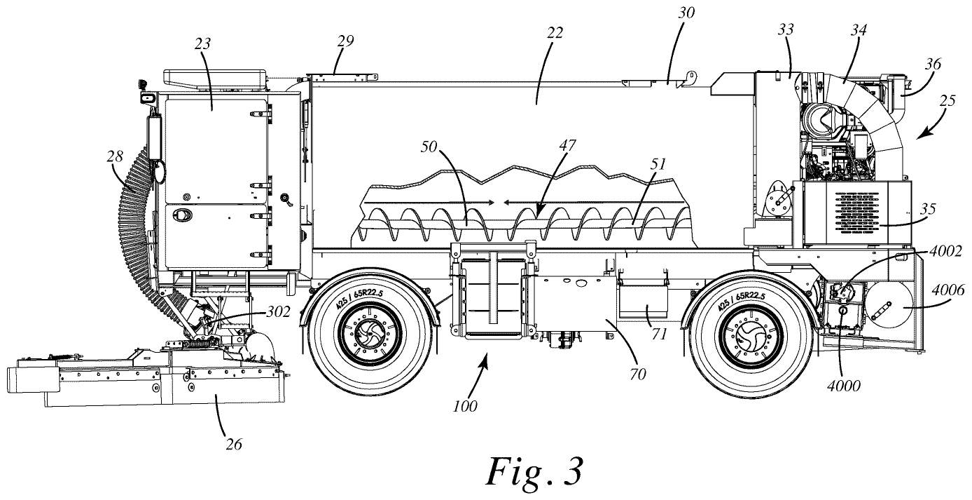

The present disclosure provides various embodiments of a vacuum truck 20, 220 that can collect and unload organic matter either beneath (See FIG. 1) or off the side (See FIG. 2) of the truck. Perhaps as best shown in FIG. 3, an auger in the storage tank can utilize opposed flighting sections 50, 51 to move the organic matter towards an outlet door. That is, one of the flighting sections 51 can be configured to move organic matter in the forward direction toward the front of the truck and the other flighting section 50 can be configured to move organic matter in the rear direction toward the rear of the truck.

For side unloading, the operator can pull the vacuum truck parallel to the unloading station, e.g., an organic matter (e.g., manure) reception pit. This approach mitigates the risk of the vacuum truck falling into the pit due to accidental forward or reverse movement or brake failure.

Regarding bottom unloading (and side unloading), the operator can position the vacuum truck over a grated unloading station 500—essentially an unloading pit 502 covered by a grate 504, as shown in FIGS. 1-2. The truck can then be driven over the grate 504 to align the vehicle for unloading, allowing organic matter to discharge through the grate into the reception pit below. This method requires significantly less precision compared to front or rear unloading. Additionally, since both side and bottom unloading use an outlet located near the bottom of the storage tank, gravity aids in the discharge process, resulting in a faster and more thorough unloading of organic matter.

FIGS. 1-2 illustrate two embodiments of a vacuum truck 20, 220. The FIG. 1 embodiment features bottom unloading while the FIG. 2 embodiment features side unloading. Both vacuum trucks 20, 220 include a self-propelled vehicle with frame 21, 221 and a storage tank 22, 222 a vacuum source 25, 225 and a scraper 26, 226 mounted on the frame 21, 221. Suction line 28, 228 connects a collection area of the scraper 26, 226 to the storage tank 22, 222 and to the vacuum source 25, 225. Each embodiment includes an auger 47, 247 along an inside bottom of the tank 22, 222. The auger 47, 247 extends along the length of the tank 22 and can be configured to control the flow of organic matter within the tank to a bottom tank outlet 90 and bottom exit chute 102 (FIG. 1) or a bottom tank outlet 290 and side unload exit chute 202 (FIG. 2). The driver's cabin 23, 223 is in front and has windows 60, 260 and mirrors 62, 262, such that vehicle unloading operations can be monitored from the cabin.

Referring to FIG. 1, the vacuum truck 20 features a bottom unloading system 100 that enables efficient and convenient discharge of collected organic matter directly beneath the vehicle. The bottom unloading system 100 includes a bottom tank outlet 90, a bottom exit chute 102, and a bottom exit chute gate. The bottom tank outlet 90 is strategically positioned along the lower portion of the storage tank 22, allowing gravity to assist in the discharge process. The bottom exit chute gate can be actuated by a hydraulic or pneumatic system that operates a robust guillotine-style gate valve. When the gate valve opens, it unseals the bottom exit chute 102, permitting organic matter to flow from the storage tank 22 through the chute and out of the vehicle. The auger 47, extending along the length of the storage tank 22, can be activated during the unloading process to agitate and move the organic matter in the storage tank toward the bottom tank outlet 90, ensuring continuous flow and preventing clogging, thereby promoting thorough emptying of the tank.

Referring to FIGS. 2-3, the vacuum truck 220 is equipped with a side unloading system 200 that enables efficient and convenient discharge of collected organic matter off to one side of the vehicle. The depicted embodiment illustrates left-side unloading, but the disclosure is not limited in this fashion. In alternative embodiments, the side unloading system 200 can be configured for right-side unloading.

The side unloading system 200 includes a bottom tank outlet 290, a side exit chute 202, and a side exit chute gate 204. In the current embodiment, the bottom tank outlet 290 is strategically positioned along the lower portion of the storage tank 22, allowing gravity to assist in the discharge process. In alternative embodiments, the outlet 290 may be offset to one side of the tank or the other. This may facilitate different routing for the side exit chute. The side exit chute gate 202 can be actuated by a hydraulic or pneumatic system that operates a robust guillotine-style gate valve. When the gate valve opens, it unseals the side exit chute 202, permitting organic matter to flow from the storage tank 22 through the chute and out of the vehicle. The auger 47, extending along the length of the storage tank 22, can be activated during the unloading process to agitate and move the organic matter in the storage tank toward the bottom tank outlet 290, ensuring continuous flow and preventing clogging, thereby promoting thorough emptying of the tank. The side unloading system 200 is particularly useful in environments where lateral discharge is preferred, such as unloading manure along the sides of crop rows or in confined spaces like narrow alleys between livestock stalls. The outlet of the side exit chute 202 can be positioned to direct organic matter away from the vehicle, preventing interference with the vehicle's wheels or undercarriage.

In some embodiments, the self-propelled manure vacuum vehicle disclosed herein may incorporate features described in U.S. Pat. No. 7,426,769 to Donald L. Mensch, filed on Apr. 20, 2006, which is hereby incorporated by reference in its entirety. Any of the various features disclosed in the '769 patent may be adapted for use in the present invention. For example, the '769 patent provides details about heating features that are designed to prevent cold stall and manure material from freezing or clogging the suction line and collection area. As another example, the '769 patent describes several configurations of various scrapers and fluffers that can be utilized in connection with the manure vacuum of the present disclose. For example, a scraper that is laterally shiftable such that the vehicle can be driven along either side of an alley. As another example, a fluffing rake (i.e., a secondary scraper) can be pivotally mounted on an outboard end of the scraper by a pivot structure. As another example, a pull back scraper can be mounted to a front of the frame to permit the vehicle to drive up to the end of an aisle or alley-way, and drop the scraper to pull back manure and the like positioned against an end wall.

Embodiments of the present disclosure include a wheeled frame 21, 221, a storage tank 22, 222 positioned in the middle of the frame 21, 221, the driver cabin 23, 223 located at the front of the frame 21, 221, and a power unit/engine 25, 225 and an air pump forming the vacuum source situated at the rear of the frame 21, 221. A scraper 26, 226 is positioned in front of the front wheels, generally under the vehicle's cabin 23, 223. The cabin 23, 223 includes windows 60, 260 and mirrors 62, 262, allowing for easy visibility of the collection and unloading operations.

Details about the vacuum system arrangement will now be described in connection with FIG. 3. While FIG. 3 illustrates a side-unloading embodiment, the vacuum source arrangement details are the same for the bottom-unloading embodiment. The vacuum system includes a vacuum inlet 302 located toward the front of the truck. A vacuum line 28 comprises a flexible lower hose—permitting the scraper 26 to move laterally without restriction—connected to the inlet 302, and an upper hose that extends into tank inlets 29, 229 for the storage tanks 22, 222. One or more access ports 30, 230 can be provided on top of the tanks 22, 222, with floating valves positioned beneath them to prevent spillage and seal the ports.

The collected bedding and manure are transported primarily by airflow created by the vacuum system 4000, which generates, for example, a vacuum force of about 10 to 15 inches of mercury using a venturi-type effect. The vacuum system 4000 can be controlled via control valving or from the cabin 23 through a user control interface. The suction head (i.e., vacuum strength) operates at a lower head pressure than blade-type vacuum units. This is advantageous because the system relies on airflow generated by a lower vacuum pressure to transport the material, reducing energy consumption and equipment wear compared to blade-type units.

In the current embodiment, air flows from the tanks 22, 222 to a centrifuge separator 33, 233 through lines 34, 234 and then to the vacuum system 4000. The vacuum system 4000 can be, for example, a vane pump or blower that is driven by a hydraulic motor 4002. The hydraulic motor 4002 is powered by pressurized hydraulic fluid supplied by a hydraulic pump 35, 235 connected to the vehicle's diesel engine 25. This setup allows the diesel engine to indirectly power the vacuum system by driving the hydraulic pump, which in turn powers the hydraulic motor and ultimately the vane pump or blower. This configuration offers flexibility in component placement and provides precise control over the vacuum system's operation, enhancing efficiency and ease of maintenance.

The auger 47 extends through the bottom of the tank 22. In some embodiments, the auger 47 extends out to a front outlet/discharge opening 48 adjacent to the cabin 23. However, in other embodiments, there is no front outlet, and the auger 47 simply extends along the length of the storage tank 22. The auger 47 is adapted to agitate the slurry of manure to prevent settling during the collection of organic matter and also facilitates dumping at a particular location. For embodiments that include a front discharge outlet, it can operate as disclosed in the '769 Patent, incorporated by reference above. For example, a guillotine-style gate can be positioned in the front discharge opening and is movable from a lowered sealing position to a raised open position. During the dump cycle, the collected stall and manure material can be urged forward by the auger 47 and flow forward to dump over the scraper and well forward of the vehicle's front wheels.

In embodiments of the present disclosure where organic matter is discharged through a bottom outlet, the auger 47 can be configured with opposed flighting sections 50. 51 to facilitate movement of the organic matter toward the center of the tank, where the bottom tank outlet 90, 290 is located. This opposed flighting is specifically designed to direct the organic matter away from the ends of the tank and toward the center, ensuring that the material is effectively funneled to the bottom outlet for discharge. This configuration allows for efficient unloading of the organic matter through the bottom exit chute, particularly when side or bottom unloading is utilized, as described in earlier sections. In one embodiment, the auger within the storage tank includes opposed flighting sections. These sections have flighting oriented in opposite directions, allowing organic matter near the front of the storage tank to be moved toward the middle, while organic matter near the rear is simultaneously moved toward the front of the tank. This configuration facilitates efficient movement of material toward the desired outlet, enhancing the effectiveness of both side and bottom unloading.

In some embodiments, the auger 47 is configured as an auger assembly composed of two portions 50, 51 with different flighting welded thereto. The flighting is opposed so that when the auger is driven, the two different flighting portions provide opposing forces of movement of the organic matter in the tank. That is, the organic matter near the auger portion in the rear 51 urges organic matter toward the front of the truck and simultaneously, the auger portion in the front 50 urges organic matter toward the center of the tank, facilitating efficient discharge through the bottom outlet 90, 290. Optionally the opposed flighting auger can be replaced with a fully forward flighting auger to allow the truck to be configured for front dumping and/or side/bottom dumping. In this scenario, the auger can urge some matter can be moved toward the middle of the tank while other matter is urged toward the front of the truck where the front outlet is disposed. Different augers offers flexibility in configuration allowing a truck to be effectively configured for either front dumping and side/bottom dumping or just side/bottom dumping depending on which auger is installed. Similarly, the auger could have full reverse flighting and be configured for rear dumping and side/bottom dumping.

In some embodiments, a hydrostatic drive system 27, 227 can be mounted to the drive chassis. A hydrostatic drive system is a form of transmission that utilizes hydraulic fluid under pressure to transmit power from the engine to the drive wheels. It generally includes one or more hydraulic pumps 35, 235 connected to the engine 25, 225, and one or more hydraulic motors that drive the drive wheels. When the operator controls the vehicle, the associated pump adjusts the flow of hydraulic fluid to the motors, which in turn changes the speed and direction of the vehicle.

The hydrostatic drive can provide a range of speeds, allowing for precise control of the vehicle's pace without the need for shifting gears. Additionally, hydrostatic drives can deliver high torque at low speeds, which can be beneficial for heavy-duty tasks in challenging terrain or under heavy loads. In the current embodiment, the hydrostatic drive provides multiple steering modes that the operator can select between, two-wheel and four-wheel steering. While the current embodiments utilize, hydrostatic drive, or essentially any other type of drive system could replace or supplement the hydrostatic drive of the current embodiments. The four wheels of the truck 20 can be a two-wheel drive with steering ability, a four wheel drive with steering ability, a “crab steer” arrangement where individual wheel rotation is individually controlled, or essentially any other drive arrangement. A total length of the present manure vacuum is about 21 feet and under 10 feet tall, which allows the vehicle to fit into alleys and tight quarters, as required in many farm, animal, and dairy operations.

A fuel tank 70 can be provided for supplying fuel to the truck's primary engine, which powers the vehicle's movement and the operation of essential systems. The engine 25, 225, fueled by the contents of the fuel tank 70. The vacuum system 4000 can be driven hydraulically or electrically. For example, in the current embodiment, the vacuum system 4000 is driven hydraulically by one of the hydraulic pumps 35, 235 and a hydraulic motor 4002. As discussed above, the hydraulic pumps 35, 235 can be driven by the diesel engine 25, 225. Alternatively, an engine (e.g., a diesel engine) can be configured as a generator to charge batteries or provide direct electrical power to run an electric motor instead of hydraulic motor 4002. The vacuum system 4000 enables the vacuum truck to effectively collect organic matter. Additionally, the engine may also power the hydraulic systems that control various components, such as the auger 47, 247, the gate valves 49, 249, and the scraper 26, 226. The placement of the fuel tank 70 can facilitate maintaining balance and efficiency, ensuring that the vehicle remains stable during operation, even when the tank is full or empty.

The battery box 71 houses the batteries that provide electrical power to the truck's auxiliary systems, including the control systems, lighting, sensors, and any electrically actuated components. These batteries ensure that the truck's electrical functions remain operational even when the engine is not running. The battery box 71 also supports the starter motor for the engine and may provide backup power to the vacuum system or other key components, ensuring that the vacuum truck remains functional in various operational scenarios.

In operation, the vacuum truck 20 can be driven along a collection area to collect manure, such as along an outer end of stalls, with the vehicle driver watching the action of the scraper 26, 226. The vehicle 20, 220 can then be navigated to a dumping area. To unload, the vehicle 20, 220 is driven up to a dumping area, and the appropriate gate 48, 248, 102, 202 is opened to dump collected manure material, and the auger 47 is operated to move the material toward the designated gate out of the tank 22 into a collection area.

During normal operation, when the vacuum truck is actively collecting organic matter from the collection area, the vacuum system 4000 generates a strong suction force that draws air and material through the suction line 28, 228 and into the storage tank 22, 222. This airflow is directed into the storage tank, where the organic matter is separated from the air stream and deposited inside the tank. The air can be cleaned and screened as well. For example, the air can be pulled through the main holding tank via outlet AAA where it is pulled through a cyclone separator 33 that separates solids and air. The vacuum system 4000 can pull the air further through a screen 4006 and sound mufflers, which can be installed to assist with screening the air and muffling the sound. During the dumping process, the airflow dynamics can be altered. Typically, the vacuum pump 4000 is shut off, and no additional pressure is applied within the tank. The vacuum pump is either disengaged or redirected, and the focus shifts from suction to facilitating the release of the organic matter. As the bottom outlet 100, 200 opens and the auger 47, 247 begins to agitate and move the material, the internal pressure within the tank may stabilize or slightly increase to assist with the discharge of the organic matter through the designated outlet, whether it be the bottom or side exit chute. This controlled change in airflow ensures that the vacuum truck efficiently transitions from collection mode to dumping mode, minimizing the risk of material blockages and ensuring a smooth, thorough release of the contents.

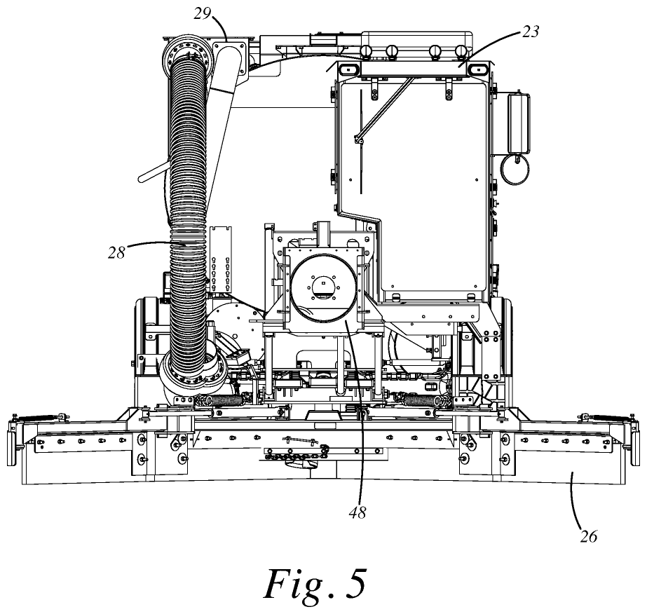

FIG. 5 provides a front view of the vacuum truck 20, illustrating features that facilitate the monitoring and operation of the side and bottom unloading systems. In this embodiment, the driver cabin 23 is offset to the side, allowing the operator an improved line of sight to observe and manage the unloading processes. This offset configuration enhances visibility during both side and bottom unloading operations, ensuring precise control and safety. Additionally, FIG. 5 depicts the front unload outlet 48, which is centrally located to allow for direct discharge of material during front unloading operations. The figure also highlights the position of the scraper 26, which is located beneath the cabin 23 and facilitates the collection process. Furthermore, the vacuum inlet pathing is clearly illustrated, showing line 28 that channels the vacuumed material from the collection area to the storage tank inlet 29. This configuration ensures efficient transfer of organic matter into the storage tank 22, optimizing the overall operation of the vacuum truck. In alternative embodiments the driver cabin can be center mounted.

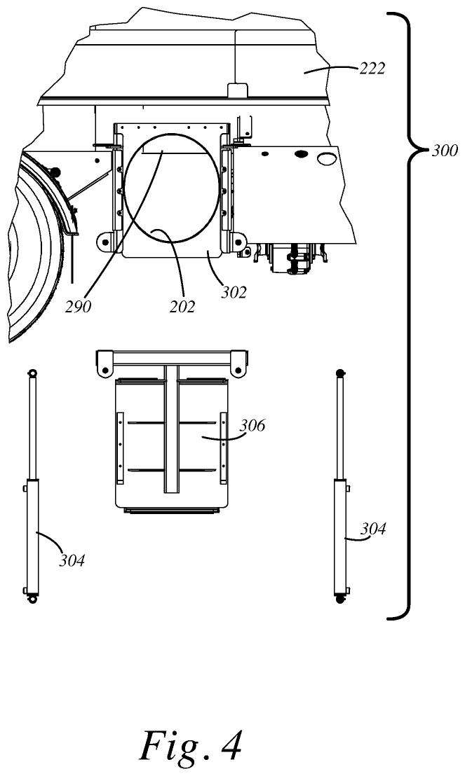

FIG. 4 illustrates an exploded view of the side unloading system 200, highlighting the vertical sliding guillotine door assembly 300 that controls the release of organic matter from the storage tank 222. The guillotine door assembly 300 includes three primary components: an exit chute outlet frame 302, hydraulic system (e.g., single or dual hydraulic cylinders) 304, and the guillotine door 306.

The exit chute outlet frame 302 is part of the side exit chute 202, which attaches securely to the storage tank 222, providing the necessary structural support and mounting points for the hydraulic cylinders 304. The frame is designed to maintain the alignment and stability of the entire assembly, ensuring that the guillotine door 306 operates smoothly. The hydraulic cylinders 304 are positioned on opposite sides of the guillotine door 306 and are operatively connected to it, enabling vertical movement. These cylinders facilitate a rapid and straight-line opening of the guillotine door 306, allowing for efficient unloading of the tank's contents during the unloading process while keeping the door assembly compact and close to the storage tank 222.

The guillotine door 306, when actuated by the hydraulic cylinders 304, slides vertically within the exit chute outlet frame 302. This movement either seals the outlet 290 to contain the organic matter within the storage tank 222 or opens fully to allow the material to flow out through the side exit chute 202. The guillotine door assembly 300 is constructed with space optimization in mind, ensuring that the mechanism remains compact and closely aligned with the storage tank 222. The materials used in the assembly are chosen for their durability and resistance to corrosion, making the guillotine door assembly 300 well-suited for the demanding conditions often encountered in vacuum truck operation.

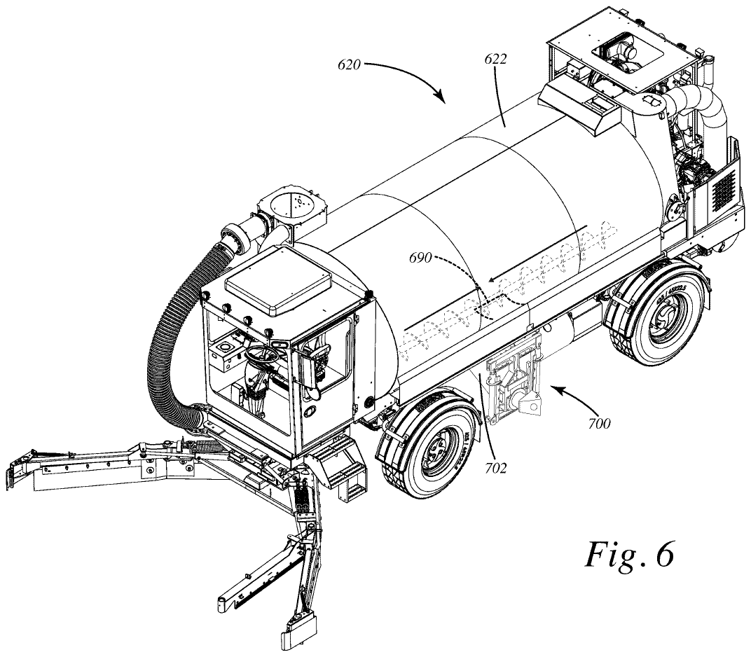

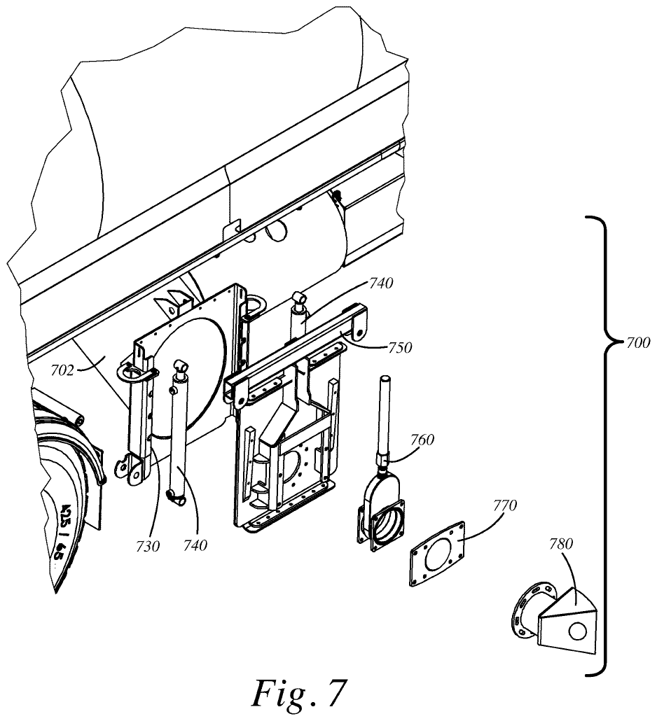

FIGS. 6 and 7 illustrate an alternative embodiment of a vacuum truck 620 with a side spreading system 700 for distributing material, such as manure, from the storage tank 622. FIG. 6 shows the side spreading system 700 integrated into a vacuum truck 620 similar to that of FIGS. 1-2, while FIG. 7 provides a close-up exploded view of the side spreading system 700. Just as with the previous embodiments, the storage tank 622 includes a storage tank outlet 690 that connects with a storage tank exit chute 702 that can be selectively sealed by a gate assembly, in this case the side spreading system 700 acts as a gate for passive unloading or a spreading system for active spreading, depending on how the gate is operated.

Referring to FIG. 7, the side spreading system 700 includes a side outlet gate mount 730, dual hydraulic cylinders 740, a guillotine door 750, a brass knife valve 760, a mounting plate 770, and a spreader head 780. The exit chute 702 extends from the storage tank outlet 690 and terminates at the side outlet gate mount 730. The guillotine door 750 is slidably mounted within the gate mount 730 and is actuated by the dual hydraulic cylinders 740 to selectively open or close the exit chute 702. The brass knife valve 760, which is electrically controlled, is positioned downstream of the guillotine door 750, further controlling the flow of material. The spreader head 780 is affixed to the brass knife valve 760 via the mounting plate 770, enabling precise material distribution when the knife valve 760 is opened.

The side spreading system 700 provides dual functionality depending on the operational desires. When the guillotine door 750 is opened, the entire contents of the storage tank 622 can be fully dumped through the exit chute 702. This mode is particularly useful for quickly offloading large volumes of material.

Alternatively, the guillotine door 750 can remain closed while the brass knife valve 760 is selectively opened, allowing material to be funneled through the spreader head 780 for controlled distribution. The spreader head 780 is affixed to the brass knife valve 760 via the mounting plate 770, ensuring stable attachment and precise material distribution during operation. This configuration is ideal for applications that require even spreading of material, such as fertilizing fields or managing organic matter in confined spaces.

The integration of the spreader head 780 with the brass knife valve 760 ensures that material distribution is both precise and consistent, minimizing waste and optimizing the application of organic matter. The dual hydraulic cylinders 740 provide reliable and powerful actuation of the guillotine door 750, ensuring smooth and responsive operation, whether in passive unloading or active spreading mode. This dual-mode capability offers significant operational flexibility, allowing the vacuum truck 620 to adapt to different tasks efficiently.

The side spreading system 700 as described represents merely one exemplary embodiment; alternative embodiments can achieve similar functionality. For example, instead of dual hydraulic cylinders 740, a single hydraulic or pneumatic cylinder can be used to actuate the guillotine door 750, providing a simpler mechanism that may be suitable for certain operational contexts. Similarly, the brass knife valve 760 may be replaced with a steel or composite valve, which could offer increased durability or reduced cost depending on the application requirements. Furthermore, the spreader head 780 and mounting plate 770 could be modified or replaced with other distribution mechanisms or attachments suited to different materials or spreading patterns. Such variations allow for flexibility in adapting the side spreading system to diverse material handling needs and operational environments without departing from the scope of the invention.

Likewise, the side unloading system 200 shown in FIG. 4 provides another example of how the disclosed invention may vary in alternative embodiments. For instance, while the guillotine door assembly 300 includes dual hydraulic cylinders 304 for actuating the guillotine door 306, alternative configurations could utilize a single hydraulic cylinder, or even an electric actuator, to achieve vertical movement of the door. The exit chute outlet frame 302 can also be adapted or constructed from different materials suited to specific environmental or structural requirements. These adjustments may provide simplified construction, increased durability, or cost efficiency, depending on the application. Such design variations in the side unloading system 200 offer additional flexibility, enabling customization for varied operational needs without straying from the invention's intended function and scope.

The present disclosure provides a versatile vacuum truck system. Different embodiments can meet varying operational requirements. Some embodiments of the vacuum truck are configured to side unload off the side of the vehicle, while others are configured for bottom unloading beneath the vacuum truck. Opposed flighting sections can direct organic matter in the tank toward the tank outlet. The auger's flighting can be reconfigured to allow the operator to switch between front unloading and side/bottom unloading. The vacuum truck can optionally incorporate a spreading mode, where material can be distributed evenly using a spreader head, facilitated by running the vacuum in reverse. These various embodiments and different modes of operation provide significant flexibility, enabling the vacuum truck to perform a range of tasks, from bulk unloading to precise material distribution, making it suitable for diverse applications in agricultural management.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner in one or more embodiments.

1. A vacuum truck to collect organic matter by vacuum and unload the organic matter off the side of the vacuum truck, comprising:
a self-propelled steerable vehicle including a frame;
a storage tank mounted on the frame, the storage tank including a bottom outlet for unloading collected organic matter;
a scraper mounted on the frame and defining a collection area for scraped organic matter;
a suction line extending from the collection area to the storage tank;
an auger in the storage tank that agitates and moves collected organic matter in the storage tank toward the storage tank bottom outlet;
an exit chute extending from the bottom outlet of the storage tank to a side of the vacuum truck for unloading collected organic matter off the side of the truck; and
a vacuum source operably connected to the collection area, the suction line, and the storage tank for creating suction to move the organic matter from the collection area along the suction line into the storage tank.

2. The vacuum truck of claim 1, wherein the auger includes two portions having opposed flighting, configured to urge movement of collected organic matter near the front of the storage tank toward the middle of the storage tank and urge movement of collected organic matter near the rear of the storage tank toward the front of the storage tank.

3. The vacuum truck of claim 1, wherein the auger includes flighting in one direction, the auger configured to urge movement of collected organic matter near the rear of the storage tank toward the bottom outlet and urge movement of collected organic matter near the middle of the storage tank toward the front of the storage tank, facilitating unloading through the bottom outlet and a front outlet.

4. The vacuum truck of claim 1, wherein the auger includes flighting in one direction, the auger configured to urge movement of collected organic matter near the front of the storage tank toward the bottom outlet and urge movement of collected organic matter near the middle of the storage tank toward the rear of the storage tank, facilitating unloading through the bottom outlet and a rear outlet.

5. The vacuum truck of claim 1, wherein the exit chute includes a guillotine-style gate valve positioned near the outlet of the storage tank, the gate valve being operable to selectively seal or open the exit chute for controlled unloading of the organic matter.

6. The vacuum truck of claim 5, further comprising one or more hydraulic cylinders mounted on the guillotine-style gate valve, the one or more hydraulic cylinders configured to provide movement of the gate valve during unloading operations.

7. The vacuum truck of claim 1, further comprising a side spreading system operably connected to the exit chute, the side spreading system configured to either passively dump or actively spread the organic matter.

8. A vacuum truck to collect organic matter by vacuum and unload the organic matter beneath the vacuum truck, comprising:
a self-propelled steerable vehicle including a frame;
a storage tank mounted on the frame, the storage tank including a bottom outlet;
a scraper mounted on the frame and defining a collection area for scraped organic matter;
a suction line extending from the collection area to the storage tank;
an auger in the storage tank that agitates and moves collected organic matter in the storage tank toward the storage tank bottom outlet;
an exit chute extending from the bottom outlet of the storage tank to a bottom of the vacuum truck for unloading collected organic matter beneath the truck; and
a vacuum source operably connected to the collection area, the suction line, and the storage tank for creating suction to move the organic matter from the collection area along the suction line into the storage tank.

9. The vacuum truck of claim 8, wherein the auger includes two portions having opposed flighting, the auger configured to urge movement of collected organic matter near the front of the storage tank toward the middle of the storage tank and urge movement of collected organic matter near the rear of the storage tank toward the front of the storage tank.

10. The vacuum truck of claim 8, wherein the auger includes flighting in one direction, the auger configured to urge movement of collected organic matter near the rear of the storage tank toward the bottom outlet and urge movement of collected organic matter near the middle of the storage tank toward the front of the storage tank, facilitating unloading through the bottom outlet and a front outlet.

11. The vacuum truck of claim 8, wherein the auger includes flighting in one direction, the auger configured to urge movement of collected organic matter near the front of the storage tank toward the bottom outlet and urge movement of collected organic matter near the middle of the storage tank toward the rear of the storage tank, facilitating unloading through the bottom outlet and a rear outlet.

12. The vacuum truck of claim 8, wherein the exit chute includes a guillotine-style gate valve positioned near the bottom outlet of the storage tank, the gate valve being operable to selectively seal or open the exit chute for controlled unloading of the organic matter.

13. The vacuum truck of claim 12, further comprising one or more hydraulic cylinders mounted, the one or more hydraulic cylinders configured to move the gate valve during unloading operations.

14. The vacuum truck of claim 8, further comprising a bottom spreading system operably connected to the exit chute, the bottom spreading system configured to either passively dump or actively spread the organic matter beneath the truck.

15. The vacuum truck of claim 8, further comprising a sensor system configured to monitor the position and flow of organic matter within the storage tank and provide feedback to the operator via the user interface.

16. A vacuum truck for collecting, unloading, and spreading organic matter, comprising:
a self-propelled steerable vehicle including a frame;
a storage tank mounted on the frame, the storage tank including a bottom outlet and a front outlet;
a scraper mounted on the frame and defining a collection area for scraped organic matter;
a suction line extending from the collection area to the storage tank
an auger positioned within the storage tank, configured to agitate and move collected organic matter toward either the bottom outlet or the front outlet of the storage tank;
a front exit chute extending from the front outlet of the storage tank to the front of the vacuum truck for unloading collected organic matter in front of the vacuum truck;
a side exit chute extending from the bottom outlet of the storage tank to a side of the vacuum truck for unloading collected organic matter off the side of the vacuum truck;
a side spreading system including a spreader head operably connected to the side exit chute, the spreader head configured to distribute the organic matter across a designated area to the side of the vacuum truck;
a front unloading system operably connected to the front outlet of the storage tank, configured to discharge organic matter from the front of the vacuum truck;
a control system operably connected to the auger, the front unloading system, and the side spreading system, the control system selectively switchable between directing organic matter to the front outlet for front unloading and directing organic matter to the side spreading system for side unloading or spreading; and
a vacuum source operably connected to the collection area, the suction line, and the storage tank for creating suction to move the organic matter from the collection area along the suction line into the storage tank.

17. The vacuum truck of claim 16, wherein the control system further comprises a user interface in the vehicle cabin, the user interface configured to provide real-time feedback to the operator regarding the auger and the flow of organic matter within the storage tank.

18. The vacuum truck of claim 16, wherein the side spreading system includes adjustable settings for controlling the width and direction of the spread, allowing the operator to customize the distribution of organic matter.

19. The vacuum truck of claim 16, wherein the auger includes flighting in one direction, the auger configured to urge movement of collected organic matter near the rear of the storage tank toward the bottom outlet and urge movement of collected organic matter near the middle of the storage tank toward the front of the storage tank, facilitating unloading through the bottom outlet and the front outlet.
